(19) United States
(12) Patent Application Publication
(10) Pub. No.: US 2021/0364332 A1
(43) Pub. Date: Nov. 25, 2021

(54) ULTRASONIC CLAMP-ON FLOW METER

(71) Applicant: The University of Warwick, Coventry (GB)

(72) Inventors: Steven Dixon, Knowle (GB); Foz Hughes, Stourbridge (GB)

(73) Assignee: The University of Warwick, Coventry (GB)

(21) Appl. No.: 17/385,135

(22) Filed: Jul. 26, 2021

Related U.S. Application Data
(63) Continuation of application No. 16/463,843, filed on May 23, 2019, now abandoned.

(30) Foreign Application Priority Data
Nov. 24, 2016 (GB) 1619907.7

(51) Int. Cl. G01F 1/66; G01F 15/00; G01F 15/14; G01K 13/02

(52) U.S. Cl. CPC G01F 1/662; G01F 1/663; G01K 13/026; G01F 15/14; G01K 13/02; G01F 15/006

(57) ABSTRACT

An ultrasonic clamp-on flow meter is disclosed. The flow meter comprises a moulded coupling element (9).

### CROSS-REFERENCE TO RELATED APPLICATIONS

The present application is a continuation application of U.S. application Ser. No. 16/463,843, filed May 23, 2019, which claims priority to PCT/GB2017/053526, filed Nov. 23, 2017, which claims priority to United Kingdom 1619907.7, filed Nov. 24, 2016, the contents of which are incorporated by reference in their entirety.

### FIELD OF THE INVENTION

The present invention relates to an ultrasonic clamp-on flow meter.

### BACKGROUND

Flow velocity of a fluid within a pipe can be used to determine properties of the fluid, such as the volumetric flow rate.

Non-destructive testing devices can be used which do not require direct mechanical contact with the fluid. This can allow measurements to be done without requiring modification of the structure of the pipe, insertion of a meter body, or obstruction of flow of the fluid.

One such non-destructive testing device is an ultrasonic clamp-on flow meter. An ultrasonic clamp-on flow meter includes at least one ultrasonic transducer which can emit and detect ultrasound and is clamped to an outer surface of the pipe. Each transducer includes a coupling element adjacent to an active element. The coupling element tends to be flat, but can also be shaped to provide a surface having a profile which follows the profile of the outer surface of the pipe. The coupling element can be shaped to provide a surface having a profile which scatters ultrasound incident at that surface.

Currently, transducers for clamp-on flow meters tend to use hard polymer materials, such as polyether ether ketone (PEEK), polymethyl methacrylate (PMMA) or a cross linked polystyrene as a coupling element material. For example, US 2016/0116318 A1 describes an ultrasonic transducer having a coupling element comprising unfilled polyetherimide. The manufacture of coupling elements including these materials tends to require machining of the material. Transducers using these materials may have a flat or profiled surface which is held in contact with the outer surface of the pipe.

This approach, however, can have one or more disadvantages. For example, the materials used for the coupling element tend to be costly and/or require significant time and cost to machine.

EP 1 248 081 A1 describes an ultrasonic transmitting-receiving device comprising a composite of a ultrasonic transducer and a ultrasonic propagating element which propagates ultrasonic wave transmitted by the transducer predominantly in the direction perpendicular to a plane of the transducer, the composite being arranged at an acute angle from the center line of the pipe and a ultrasonic propagating layer placed between the ultrasonic propagating element and the pipe.

### SUMMARY

According to a first aspect of the present invention there is provided an ultrasonic clamp-on flow meter comprising a moulded coupling element or, optionally, a flexible membrane coupling element for forming a surface of a liquid-filled chamber.

This can allow a transducer for a clamp on flow meter to be fabricated cheaply and easily. Machining of the coupling element material may not be required.

The coupling element or the membrane may comprise an elastomer. The coupling element may comprise a mouldable material. The mouldable material may be a material which is flowable at a first temperature (for example, a temperature which is equal to or greater than 90° C. or 110° C.) and is not flowable at a second, lower temperature (for example, at a temperature which is equal to or less than 80° C. or 60° C.). The mouldable material may comprise acrylonitrile butadiene styrene (ABS). The coupling element may comprise a thermosetting polymer. The coupling element may comprise an epoxy elastomer, for example, an elastomer epoxy resin.

The coupling element may comprise an active element disposed on or supported by the coupling element. A passive layer may be interposed between the coupling element and the active element.

The coupling element may have a generally truncated wedge shape having a base face, a top face, first and second opposite end faces, first and second opposite side faces and a chamfered face running between the top face and the first end face.

The coupling element may comprise at least one moulded scattering element. The moulded scattering element and the coupling element may be single piece and may comprise the same material. The coupling element may comprise an array of scattering elements.

The coupling element may be disposed in a housing. The housing may be single piece or may comprise two or more connectable parts.

The housing may comprise a generally hollow truncated wedge. The housing may comprise a plurality of portions (or “walls”) including a top portion, first and second opposite end portions, first and second opposite side portions and a chamfered portion running between the top portion and the first end portion. The housing may have an open base, in other words, the housing may not comprise a base portion.

The housing may have an aperture, for example in the chamfered portion, for accommodating an active element. The active element may be disposed in the aperture. The aperture may support the active element.

The housing may comprise an open face, i.e. the housing may have no housing portion for that face. This can provide a region for contact between the coupling element and an object under test, for example, a pipe.

The housing may have an inner face, for example the inner face of the second end portion, comprising at least one inwardly-projecting member for reducing ultrasonic reverberations in the ultrasonic transducer. The inner face may comprise an array of inwardly-projecting members. The inwardly-projecting members may be wedges. The wedges may be pyramidal.

The clamp-on flow meter may further comprise an insert lying against an inner face of the housing. The insert may have first and second opposite faces. The first face of the insert may comprise at least one projecting member, for example an array of projecting members. The projecting members may be wedges. The wedges may be pyramidal. The insert may be disposed in the housing such that the second face of the insert lies against the inner face of the housing and the first face of the insert faces inwardly into the housing.

The coupling element may comprise a material which is pliable at an operating temperature of the flow meter. The coupling element may comprise a material which is not pliable at an operating temperature of the flow meter. An operating temperature of the flow meter may be no more than −20° C., no more than 0° C. or no more than 20° C. An operating temperature of the flow meter may be at least 20° C., at least 50° C., at least 100° C., at least 150° C., or at least 200° C. The flowmeter may be operated in a cryogenic environment, that is, an operating temperature of the flow meter may be no more than −200° C. or no more than −160° C.

The liquid may be an oil, such as a mineral oil or grease, gel or other acoustically-conductive liquid having a low acoustic absorption.

According to a second aspect of the present invention, there is provided an energy meter comprising an ultrasonic clamp-on flow meter according to the first aspect of the invention. The energy meter may comprise at least one temperature probe.

According to a third aspect of the present invention there is provided a method of fabricating an ultrasonic transducer for use in a clamp on flow meter. The method comprises providing a mould and disposing a mouldable material or a deformable element in the mould so as to form a coupling element.

The method may further comprise disposing an active element on the coupling element.

The mould may be a housing. Disposing the mouldable material in the mould may comprise injecting the material. Disposing the mouldable material in the mould may comprise pouring the material. Disposing the mouldable material in the mould may comprise disposing the mouldable material in the mould under vacuum conditions. Disposing the mouldable material in the mould may comprise evacuating the mould of air prior to disposing the mouldable material in the mould. The mouldable material is preferably liquid (i.e. is flowable) when disposing the mouldable material in the mould.

The method may further comprise allowing the mouldable material to set or cure. The mouldable material may be allowed to set or cure at room temperature, i.e. at about 22° C. The method may comprise applying heat to the mouldable material. The method may comprise applying heat to the mould. The method may further comprise removing the coupling element from the mould.

Disposing the deformable element in the mould may comprise disposing a liquid-filled membrane in the mould. Disposing the deformable element in the mould may comprise disposing a membrane in the mould and filling the membrane with a liquid, such as an oil. The method may further comprise evacuating the membrane of air. The method may further comprise sealing the membrane.

### BRIEF DESCRIPTION OF THE DRAWINGS

Certain embodiments of the present invention will now be described, by way of example, with reference to the accompanying drawings, in which:

FIG. 1 is a perspective view of a pipe and a fluid flowing through the pipe;

FIG. 2 is a transverse cross-sectional view of a pipe, a fluid flowing through the pipe, and first and second transducers clamped to the outer surface of the pipe;

FIG. 3 is a perspective view of an ultrasonic transducer;

FIG. 4 is a cross-sectional view of the ultrasonic transducer shown in FIG. 3 taken along the line A-A′;

FIG. 5 is a perspective view of a first housing for an ultrasonic transducer;

FIG. 6 is a cross-sectional view of the first housing shown in FIG. 5 taken along the line B-B′;

FIG. 7 is a cross-sectional view of an ultrasonic transducer disposed within a first housing;

FIG. 8 is a perspective view of a second housing for an ultrasonic transducer;

FIG. 9 is a cross-sectional view of a second housing shown in FIG. 8 taken along the line C-C′;

FIG. 10 is a perspective view of a third housing for an ultrasonic transducer;

FIG. 11 is a cross-sectional view of a third housing shown in FIG. 10 taken along the line D-D′;

FIG. 12 is a perspective view of a housing insert;

FIG. 13 is a perspective view of a third housing for an ultrasonic transducer and a housing insert disposed in the third housing;

FIG. 14 is a perspective view of a modified housing insert;

FIG. 15 is a process flow diagram of fabricating a first ultrasonic transducer;

FIGS. 16a to 16c are cross-sectional views through a plane parallel to a back face of a first ultrasonic transducer during a fabrication process;

FIG. 17 is a cross-sectional view of a second ultrasonic transducer disposed within a first housing;

FIG. 18 is a process flow diagram of method fabricating a second ultrasonic transducer;

FIG. 19 is a cross-sectional view of a flow meter in contact with a pipe; and

FIG. 20 is a transverse cross-sectional view of a pipe and an energy meter.

### DETAILED DESCRIPTION OF CERTAIN EMBODIMENTS

In the following, like parts are denoted by like reference numerals.

Referring to FIG. 1, a cylindrical pipe 1 is shown in which a fluid 2 flows along the longitudinal axis L of the pipe 1 with a flow velocity v_{f}. The flow velocity v_{f} can be measured without mechanical contact with the fluid 2 using ultrasonic waves.

A transit time method of measuring fluid flow will now be described.

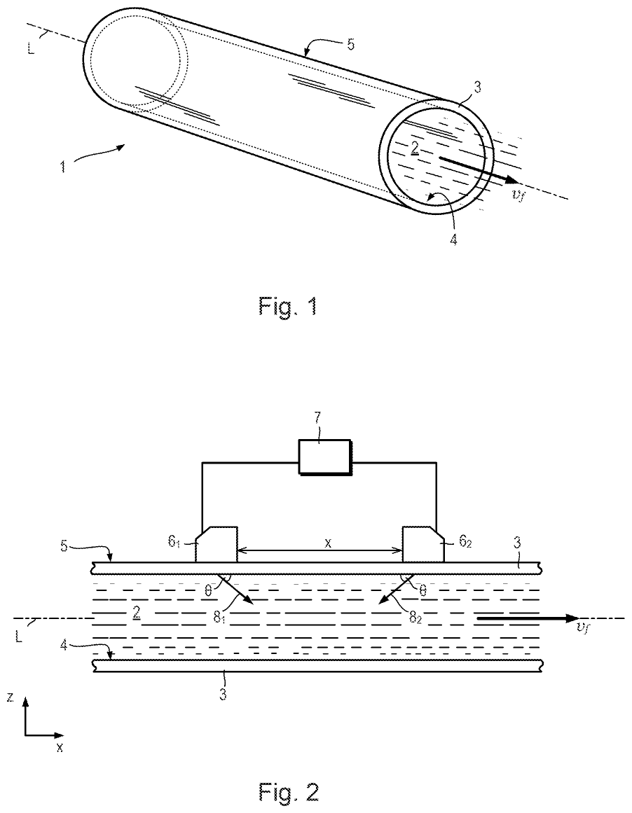

Referring also to FIG. 2, the cylindrical pipe 1 comprises a wall 3 having inner and outer surfaces 4, 5. First and second ultrasonic transducers 6₁, 6₂ are clamped to the outer surface 5 of the pipe 1 and are spaced apart in line along the pipe 1. The first and second transducers 6₁, 6₂ are separated by a distance x along the pipe 1.

The first and second transducers 6₁, 6₂ are electrically connected to a controller 7. The controller 7 can send respective signals to each transducer 6₁, 6₂ to cause each transducer to emit a respective ultrasonic pulse 8₁, 8₂. The controller 7 can receive respective signals (not shown) from each transducer 6₁, 6₂ indicative of that transducer having detected an ultrasonic pulse. A measurement of the flow velocity v_{f} of the fluid 2 is undertaken by causing the first and second ultrasonic transducers 6₁, 6₂ to alternately emit and detect pulses of ultrasound which propagate with or against the flow of fluid 2 within the pipe 1.

The first and second transducers 6₁, 6₂ emit first and second ultrasonic pulses 8₁, 8₂ respectively towards the pipe 1 inclined at an angle θ with respect to the longitudinal axis L of the pipe 1. The first and second pulses 8₁, 8₂ propagate through the pipe wall 3 and into the fluid 2, are reflected by the inner surface 4 of the pipe wall 3, propagate back through the fluid 2 and the pipe wall 3, and are detected by the second and first transducers 6₂, 6₁ respectively.

The first and second pulses 8₁, 8₂ propagate in the fluid 2 at an angle θ to the axis of the pipe 1. When the fluid 2 has a non-zero flow velocity v_{f} along the axis of the pipe 1, the speed of the pulses 8₁, 8₂ changes relative to the speed of sound in the fluid 2 when the fluid is stationary. The speed of the pulses 8₁, 8₂ depends on the direction of propagation of the pulses 8₁, 8₂ relative to the flow velocity of the fluid 2.

The first pulse 8₁ is emitted by the first transducer 6₁ and is detected by the second transducer 6₂ at a time t₁ after emission. The second pulse 8₂ is emitted by the second transducer 6₂ and is detected by the first transducer 6₁ at a time t₂ after emission.

By measuring the transit times t₁, t₂, and, optionally, applying correction factors which may depend on, for example, the profile of the pipe or the flow rate of the fluid 2, the flow velocity v_{f} of the fluid 2 can be determined.

Other paths can be used for a transit time measurement.

A calibration procedure may also be performed. A clamp-on flow meter may additionally or alternatively determine a phase shift between the first and second pulses 8₁, 8₂.

Clamp-on flow meter measurements are not limited to transit time measurements. For example, a Doppler shift method may be appropriate for measuring characteristics of fluids containing scattering particles. A flow meter for performing Doppler shift measurements includes at least one ultrasonic transducer. The at least one ultrasonic transducer may emit an ultrasonic pulse and detect the same ultrasonic pulse after scattering of the pulse by a scattering particle, which may be, for example, a bubble. Thus, only one ultrasonic transducer may be required in a Doppler shift flow meter. A flow meter for performing Doppler shift measurements may determine a frequency difference between the emitted ultrasonic pulse and the detected ultrasonic pulse.

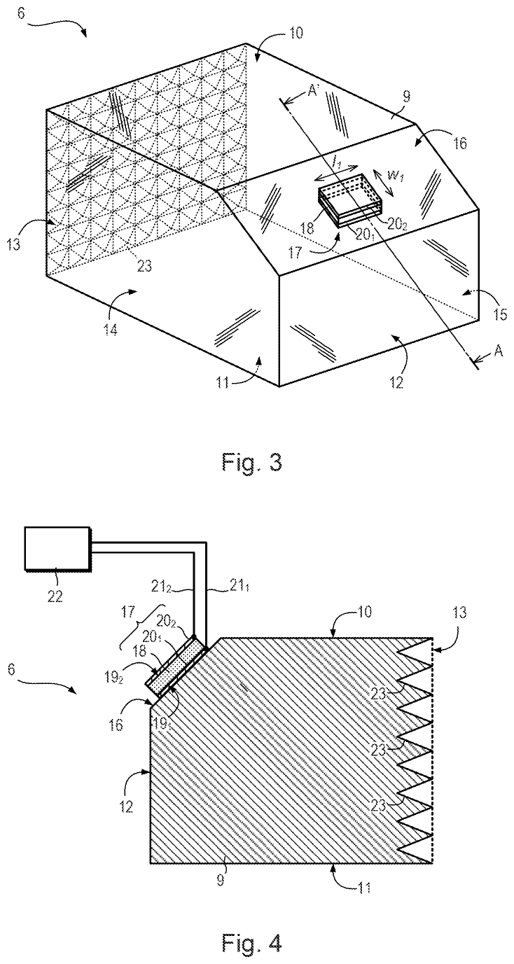

Referring to FIGS. 3 and 4, a first ultrasonic transducer 6 is shown which can be used in a clamp-on flow meter. The first transducer 6 includes a coupling element 9. The coupling element 9 generally has the shape of a truncated wedge and has top and bottom faces 10, 11, front and back faces 12, 13, and first and second opposite side faces 14, 15. The top face to and the front face 12 are joined by an angled face 16 (or “chamfer”) which is oriented at an angle to the plane of the top face to and to the plane of the front face 12.

The transducer 6 includes an active element 17 disposed on the angled face 16. The active element 17 comprises a piezoelectric element 18. The piezoelectric element 18 may comprise, for example, a ceramic, such as lead zirconate titanate, or a piezoelectric polymer, such as polyvinylidene fluoride (PVDF). The piezoelectric element 18 has first and second opposite faces 19₁, 19₂. First and second rectangular planar electrodes 20₁, 20₂ are disposed on first and second opposite faces 19₁, 19₂ respectively.

The first and second electrodes 20₁, 20₂ are electrically connected to first and second leads 21₁, 21₂ respectively. The first and second leads 21₁, 21₂ are electrically connected to a controller 22. The controller 22 may transmit electrical signals to and receive electrical signals from the first and second leads 21₁, 21₂.

The active element 17 may operate in a transmissive mode and in a receiving mode. In the transmissive mode, the active element 17 converts electrical signals received through the first and second leads 21₁, 21₂, for example applied voltages, into mechanical vibrations. In the receiving mode, the active element 17 converts mechanical vibrations into electrical signals which are subsequently transmitted through the first and second leads 21₁, 21₂.

The active element 17 is disposed on the angled face 16 such that one of the first and second electrodes 20₁, 20₂ is in contact with the angled face 16. The active element 17 has a width w₁ and a length l₁. The width w₁ and length l₁ are measured along perpendicular sides of the first and second rectangular planar electrodes 20₁, 20₂ and in the plane of the first electrode 20₁ or the second electrode 20₂.

The coupling element 9 comprises a mouldable material. The mouldable material may comprise an elastomer, for example silicone elastomer. The mouldable material may comprise a rubber, a silicone rubber, or other polymer material with suitable ultrasonic properties. For example, the mouldable material may comprise latex. The mouldable material is preferably flowable (during fabrication) and so, for example, a gel (which is not flowable) is not used.

The back face 13 of the coupling element 9 is shaped to form scattering elements 23. The scattering elements 23 project inwards, into the body of the coupling element 9, from the back face 13. The scattering elements 23 take the form of pyramids, although other shapes having angled and/or curved reflecting surfaces can be used.

The coupling element 9 can help to transmit vibrations from the active element 17 to an object (not shown) placed in contact with the bottom face 11 of the coupling element 9. The object (not shown) may be an outer surface of a pipe or a structural feature on a pipe.

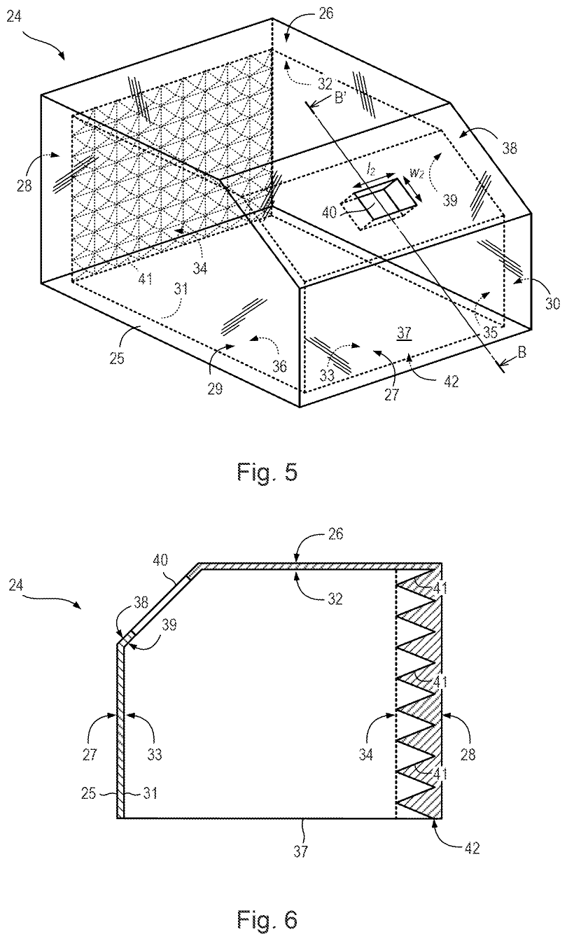

Referring also to FIGS. 5 and 6, the coupling element 9 may be housed or contained in a first housing 24.

The first housing 24 is hollow and has a truncated wedge shape with outer and inner surfaces 25, 31. The housing 24 is formed from a suitable rigid material, for example a metal or metal alloy, such as aluminium or stainless steel, or suitably rigid plastic. The outer surface 25 has a top outer face 26, front and back outer faces 27, 28, and first and second outer opposite side faces 29, 30. The inner surface 31 has a top inner face 32 (best shown in FIG. 6), front and back inner faces 33, 34 (best shown in FIG. 6), and first and second inner opposite side faces 35, 36. The housing 24 has an open bottom face 42 having an opening 37.

The top outer face 26 and the front outer face 27 are joined by an angled outer face 38 which is oriented at an angle to the plane of the top outer face 26 and to the plane of the front outer face 27. The top inner face 32 and the front inner face 33 are intersected by an angled inner face 39 which is oriented at an angle to the plane of the top inner face 32 and to the plane of the front inner face 33.

The angled outer and inner faces 38, 39 are connected by a rectangular aperture 40. The rectangular aperture 40 has a width w₂ and a length l₂ measured in perpendicular directions in the plane of the angled outer face 38.

The back inner face 34 of the first housing 24 is shaped to form an array of projections 41 which project inwards away from the back inner face 34. The projections 41 are pyramidal, although other shapes can be used.

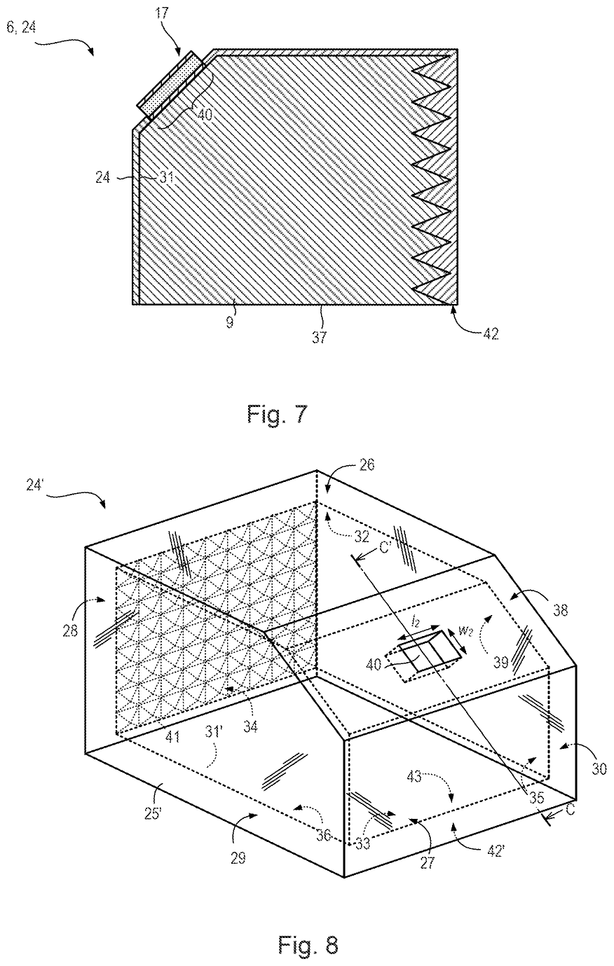

Referring also to FIG. 7, in some embodiments, the first ultrasonic transducer 6 is housed in the first housing 24.

The coupling element 9 conforms to (in other words, follows the shape of) the inner surface 31 of the housing 24. The width w₂ of the aperture 40 is substantially the same as the width w₁ of the active element 17. Additionally or alternatively, the length l₂ of the aperture may be substantially the same as the length l₁ of the active element 17. This can help to hold the active element 17 in position. The active element 17 may additionally or alternatively be held in place using an adhesive (not shown).

As will be explained in more detail later, the transducer 6 may be fabricated within the housing 24 to form an integrated unit. Alternatively, the transducer 6 may be removed from the housing 24 after fabrication. The housing 24 may comprise two or more joinable or separable parts (not shown) to allow the transducer 6 to be removed from the housing 24 after fabrication.

The bottom 11 of the coupling element 9 need not be flush with the bottom face 42 of the housing 24. For example, the coupling element 9 may project through the opening 37.

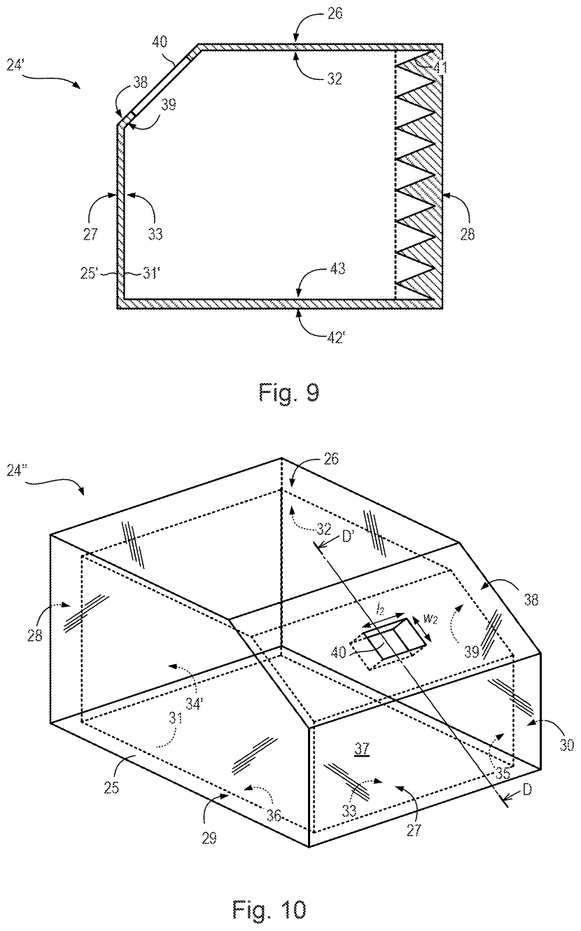

Referring to FIGS. 8 and 9, a second housing 24′ is shown. The second housing 24′ is the same as the first housing 24 (FIG. 6) hereinbefore described except that the opening 37 (FIG. 6) is not present. The outer surface 25′ of the second housing 24′ has an outer bottom face 42′ and the inner surface 31′ of the second housing 24′ has an inner bottom face 43.

Referring again to FIG. 5, the scattering members 41 (e.g. pyramidal-shaped projections) are integrally formed with the housing 24. The scattering members 41 may, however, be fabricated separately and inserted into the housing.

Referring to FIGS. 10 and 11, a third housing 24″ is shown. The third housing 24″ is the same as the first housing 24 (FIG. 6) hereinbefore described except that a back inner face 34′ of the third housing 24″ is not shaped to form projections. The back inner face 34′ of the third housing 24″ is flat (or “planar”).

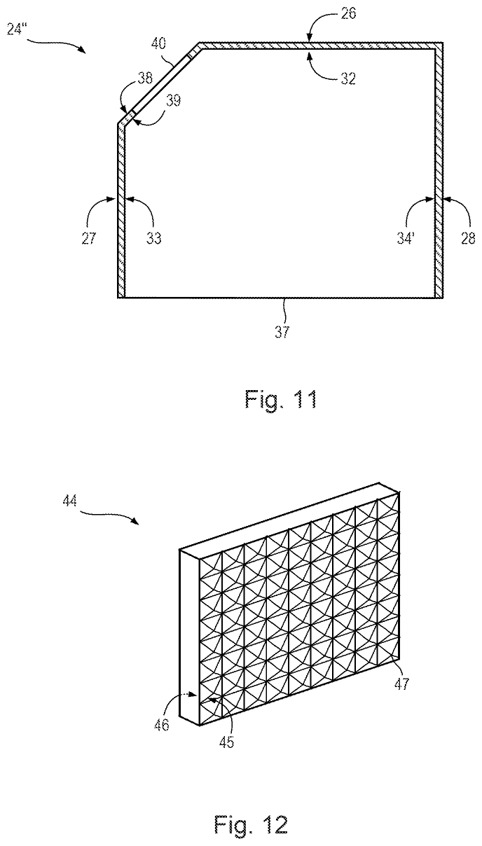

Referring to FIG. 12, a housing insert 44 (herein also referred to simply as an “insert”) is shown. The insert 44 takes the form of a sheet having first and second opposite faces 45, 46 respectively. The housing insert 44 is shaped to form an array of projections 47 across the first face 45.

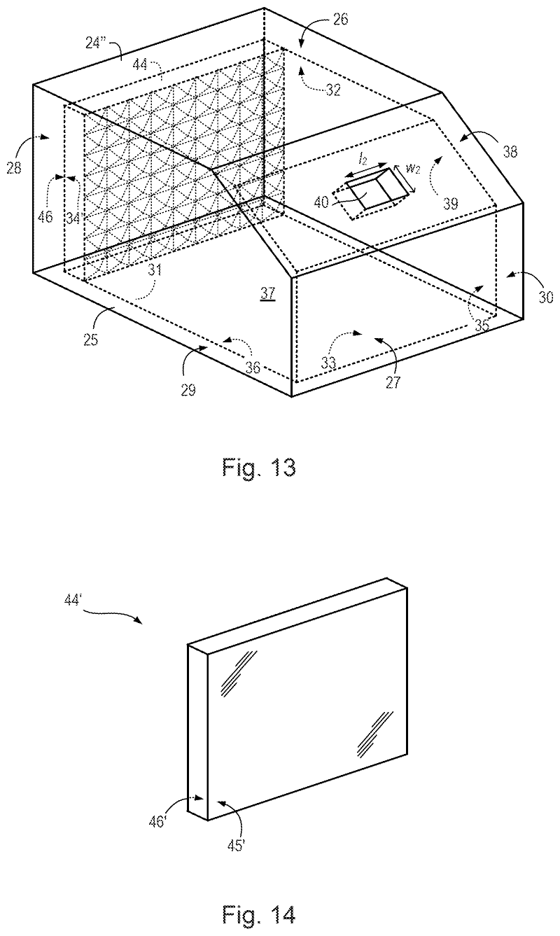

Referring also to FIG. 13, the insert 44 may be placed in the third housing 24″ with the second face 46 of the insert 44 lying against the back inner face 34′ of the housing 24″. Thus, the projections 47 point inwardly into the cavity of the housing 24″.

Referring to FIG. 14, a modified insert 44′ is shown. The modified insert 44′ takes the form of a sheet having first and second opposite faces 45′, 46′. The modified insert 44′ comprises one or more materials having suitable acoustic scattering or absorption properties. For example, the modified insert 44′ may comprise a composite material comprising a mixture of first and second phases. The first phase may comprise a polymer, for example, a rubber or elastomer. The second phase may comprise a particulate material, for example, glass beads, glass spheres, ceramic particles, metal particles.

The modified insert 44′ may be disposed in the housing 24″ in such a way that the modified insert 44′ covers the back inner face 34′ of the third housing 24″. The modified housing insert 44′ can help to scatter or absorb sound which is incident on the modified insert 44′.

Alternatively, the third housing 24″ may be provided without the housing insert 44 or the modified housing insert 44′.

A method of fabricating an ultrasonic transducer 6 will now be described with reference to FIG. 15.

A pre-fabricated housing 24, 24′, 24″ is provided (step S1501). The coupling element material is disposed in the housing 24, 24′, 24″ (step S1502). For example, the coupling element material may be poured into the housing 24, 24′, 24″. The coupling element material may be introduced into the housing 24, 24″ through the open face. Alternatively, the coupling element material may be introduced into the housing 24, 24′, 24″ through the aperture.

The coupling element material is allowed to set or cure (step S1503). During setting or curing, heat may be applied to the coupling element material and additionally or alternatively to the housing 24, 24′, 24″. This can help to initiate and/or accelerate curing.

The coupling element material may be placed in a vacuum prior to disposal of the coupling element material in the housing 24, 24′, 24″. This can help to eliminate air bubbles from the coupling element material. Additionally or alternatively, the housing and coupling element material may be placed in a vacuum after disposal of the coupling element material in the housing 24, 24′, 24″ and before any setting or curing steps. This can help to eliminate air bubbles from the coupling element material.

An active element 17 (FIG. 4), for example a piezoelectric element, may be placed on or against the coupling element material before the coupling element material is allowed to set or cure (that is, before step S1503) or after the coupling element material is allowed to set or cure.

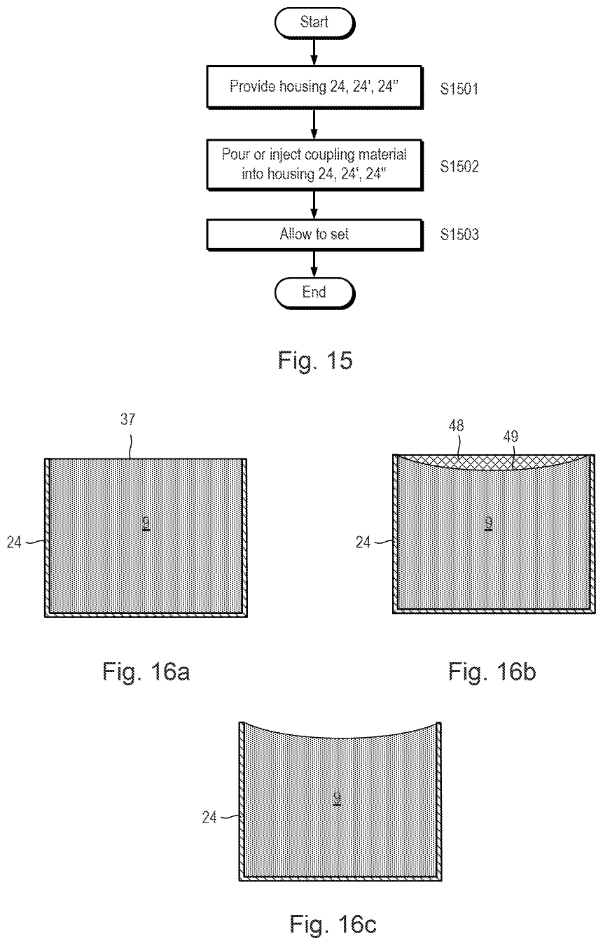

Referring to FIGS. 16a to 16c, the method may further comprise moulding the coupling element material.

After the coupling element material is disposed in the housing 24, 24″ as shown in FIG. 16a, a blanking plate 48 is placed in the opening 37 of the housing 24, 24″ as shown in FIG. 16b. The blanking plate 48 has a surface 49 with a profile which may be the same or similar to a surface profile of a pipe 1 to which the transducer 6 is desired to be fixed. The surface 49 contacts the coupling element material through the opening 37 of the housing 24, 24″. The blanking plate 48 is removed after the coupling element material has set or cured as shown in FIG. 16c.

The method may further comprise disposing a housing insert 44 (FIG. 12), 44′ (FIG. 14) in the housing 24″ before the coupling element material is disposed in the housing 24″.

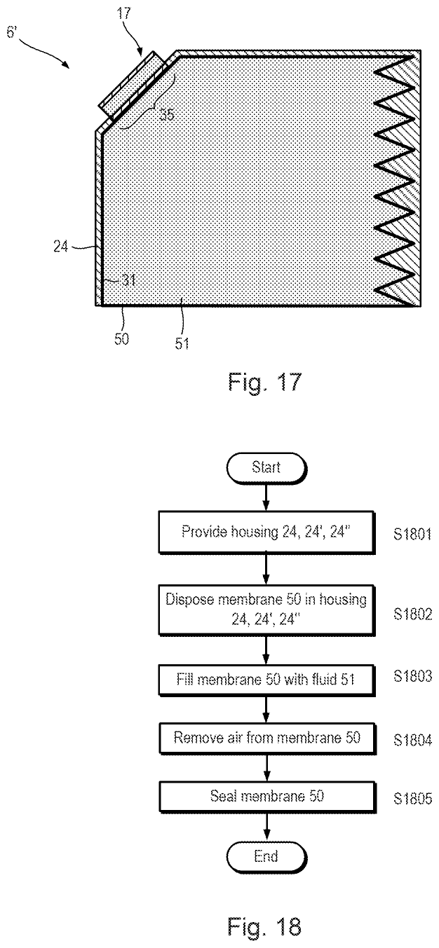

Referring to FIG. 17, a second ultrasonic transducer 6′ which can be used in a clamp-on flow meter is shown.

The second ultrasonic transducer 6′ includes a housing 24 as hereinbefore described. Although the first housing 24 is illustrated in FIG. 17, the second housing 24′ (FIG. 8) or the third housing 24″ (FIG. 10) may be used. A coupling element comprising a membrane 50 filled with a liquid 51, such as oil, grease, gel, or other suitable acoustically-conductive liquid having a low acoustic absorption, is disposed in the housing 24. The membrane 50 may comprise an elastomer, a rubber, a polymer, or other suitable material permitting propagation of ultrasonic waves. The liquid 51 may comprise water, oil, or another liquid.

The membrane 50 filled with liquid 51 conforms to the inner surface 31 of the housing 24.

A method of fabricating an ultrasonic transducer 6′ will now be described with reference to FIG. 18.

A housing 24 (FIG. 6), 24′ (FIG. 9), 24″ (FIG. 11) is provided (step S1801). The membrane 50 is disposed in the housing 24, 24′, 24″ (step S1802). The membrane 50 is filled with liquid 51 (step S1803). The membrane 50 is evacuated of air (step S1804). The membrane 50 is sealed (step S1805).

Alternatively, the membrane 50 may be filled with liquid 51 before the membrane 50 is placed in the housing 24, 24′, 24″, that is, step S1803 may occur before step S1802. The membrane 50 may be filled with liquid 51 and evacuated of air before the membrane 50 is disposed in the housing 24, 24′, 24″, that is, steps S1803 and S1804 may occur before step S1802. The membrane 50 may be filled with liquid 51, evacuated of air, and sealed before the membrane 50 is disposed in the housing 24, 24′, 24″, that is, steps S1803, S1804, and S1805 may occur before step S1802.

The method may further comprise disposing a housing insert 44, 44′ in the housing 24″ before the membrane 50 is disposed in the housing 24″.

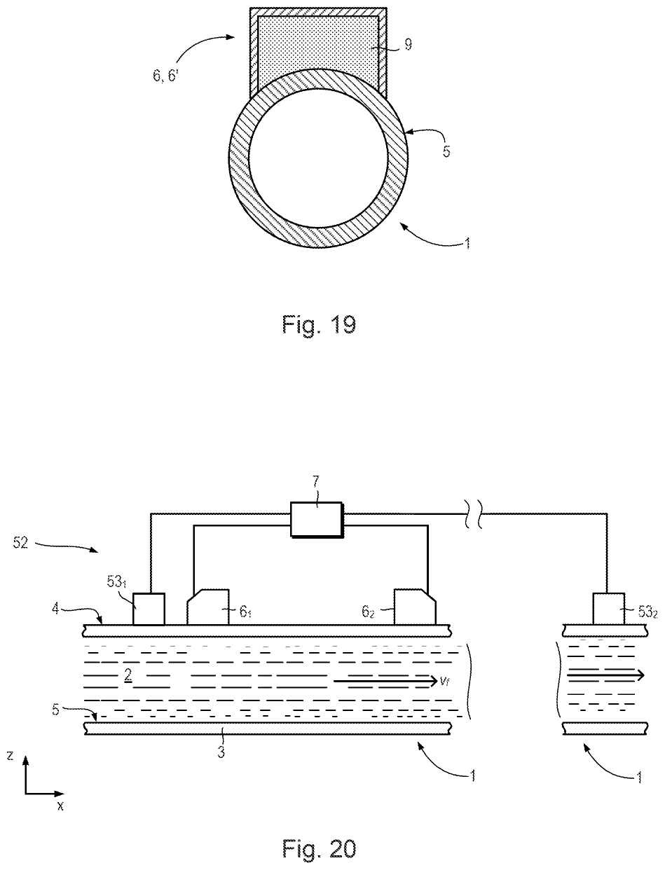

Referring to FIG. 19, an ultrasonic transducer 6, 6′ is clamped to an outer surface 5 of a pipe 1. A coupling element 9 conforms to the outer surface 5 of the pipe 1. The coupling element 9 may comprise a material which is pliable at an operating temperature of the transducer 6, 6′. The coupling element 9 may comprise a material which has been shaped to provide a surface having a profile which follows the profile of the outer surface of the pipe. For example, the coupling element 9 may comprise acrylonitrile butadiene styrene (ABS).

Referring to FIG. 20, an energy meter 52 includes first and second ultrasonic transducers 6₁, 6₂ and first and second temperature probes 53₁, 53₂. First and second ultrasonic transducers 6₁, 6₂ are clamped to the outer surface 4 of the pipe 1 and are spaced apart in line along the pipe 1. First and second temperature probes 53₁, 53₂ are in thermal contact with the outer surface 4 of the pipe 1 and are spaced apart in line along the pipe 1.

First and second ultrasonic transducers 6₁, 6₂ and first and second temperature probes 53₁, 53₂ are electrically connected to controller 7. By calculating the difference between the temperatures measured by first and second temperature probes 53₁, 53₂ respectively and by calculating a flow rate of fluid 2 flowing in the pipe 1 as described earlier, a heat flow rate of the fluid 2 may be determined.

An energy meter 52 may be used to determine the heat flow rate into or out of a fluid in a pipe passing through a unit (not shown) such as a building. For example, the first temperature probe 53₁ may be placed in contact with the pipe at a point of entrance to the unit and the second temperature probe 53₂ may be placed in contact with the pipe at a point of exit from the unit.

It will be appreciated that various modifications may be made to the embodiments hereinbefore described.

The scattering elements may have any appropriate shape, that is, the scattering elements need not be triangular in cross-section. For example, the scattering elements may be circular or rectangular in cross-section.

The electrodes of the active element may have a shape other than rectangular. For example, the electrodes of the active element may be disk shaped. The electrodes of the active element may be square. The aperture of the housing may be shaped so as to receive the active element. For example, if the electrodes of the active element are disk shaped, then the aperture may be circular.

The active element may be held in place using an adhesive with suitable acoustic properties or by a suitable positioning or clamping device or component. The active element may be acoustically coupled to a pipe using a couplant, for example a grease couplant such as polytetrafluoroethylene, a liquid couplant such as propylene glycol, a gel couplant such as glycerin, an adhesive couplant such as cyanoacrylate.

Clamp-on flow measurements are not restricted to measurement of fluids flowing through a cylindrical pipe. A pipe through which a fluid flows may have a cross section which is not circular. For example, the cross section may be rectangular or square.

One of the first and second electrodes may wrap around the piezoelectric material such that both electrode connections may be made from the same side of the active element, for example, the side which is not adjacent to the coupling element.

The coupling element may comprise a recess and the active element may be disposed in the recess.

The housing 24, 24′, 24″ need not comprise a metal. The housing 24, 24′, 24′ may comprise any rigid material which is significantly different in acoustic properties to the coupling element.

The active element need not be in direct contact with the coupling element. For example, an intermediate material may be disposed between the active element and the coupling element.

The intermediate material may be a metal such as aluminium, a ceramic, a glass, a polymer, a layer of grease or oil. The intermediate material may be a material having a thickness and acoustic properties chosen to maximise the transfer of acoustic energy between the active element and the coupling element.

1. An ultrasonic clamp-on flow meter comprising a moulded coupling element.

2. A clamp-on flow meter according to claim 1, wherein the moulded coupling element comprises an elastomer.

3. A clamp-on flow meter according to claim 1, further comprising an active element disposed on the coupling element.

4. A clamp-on flow meter according to claim 1, wherein the moulded coupling element comprises at least one moulded scattering element.

5. A clamp-on flow meter according to claim 4, wherein the at least one moulded scattering element and the coupling element comprise the same material.

6. A clamp-on flow meter according to claim 1, wherein the coupling element is disposed in a housing.

7. A clamp-on flow meter according to claim 6, wherein the housing has an aperture and the active element is disposed in the aperture.

8. A clamp-on flow meter according to claim 7, wherein the aperture supports the active element.

9. A clamp-on flow meter according to claim 6, wherein the housing comprises a face which is open.

10. A clamp-on flow meter according to claim 6, wherein the housing comprises an inner face comprising at least one projection extending in a direction away from the inner face.

11. A clamp-on flow meter according to claim 6, wherein the housing comprises an inner face, wherein the clamp-on flow meter further comprises a housing insert, wherein a first face of the housing insert comprises at least one projection extending in a direction away from the first face, wherein the housing insert is disposed in the housing such that the second face of the housing insert is flush with the inner planar face of the housing.

12. A clamp-on flow meter according to claim 1, wherein the coupling element comprises a material which is pliable at an operating temperature of the flow meter.

13. A clamp-on flow meter according to claim 1, wherein the coupling element comprises a material which is not pliable at an operating temperature of the flow meter.

14. A clamp-on flow meter according to claim 1, wherein the coupling element comprises a thermosetting plastic.

15. An energy meter comprising:
a clamp-on flow meter, the clamp-on flow meter including a moulded coupling element; and
at least one temperature probe.

16. A method of fabricating an ultrasonic transducer, the method comprising:
providing a mould; and
disposing a mouldable material or a deformable element in the mould so as to form a coupling element.

17. A method according to claim 18, further comprising:
disposing an active element on the coupling element.

18. A method according to claim 18, wherein the mould is a housing.

19. A method according to claim 18, wherein disposing the mouldable material in the mould comprises injecting the material.

20. A method according to claim 18, wherein disposing the mouldable material in the mould comprises pouring the material.

21. A method according to claim 18, further comprising:
allowing the mouldable material to set or cure.

22. A method according to claim 18, further comprising:
applying heat to the mouldable material and/or the mould.

23. A method according to claim 18, further comprising:
removing the coupling element from the mould.
